(19) United States
(12) Patent Application Publication
(10) Pub. No.: US 2016/0337087 A1
(43) Pub. Date: Nov. 17, 2016

(54) TWO-STAGE TRANSMISSION OF FEEDBACK FOR A DOWNLINK TRANSMISSION

(71) Applicant: QUALCOMM Incorporated, San Diego, CA (US)

(72) Inventors: Wanshi Chen, San Diego, CA (US); Shimman Arvind Patel, San Diego, CA (US); Aleksandar Damnjanovic, Del Mar, CA (US)

(21) Appl. No.: 15/081,597

(22) Filed: Mar. 25, 2016

Related U.S. Application Data
(60) Provisional application No. 62/160,367, filed on May 12, 2015.

(51) Int. Cl. H04L 1/18; H04W 72/12

(52) U.S. Cl. CPC H04L 1/1812; H04W 72/1231

(57) ABSTRACT

Methods, systems, and devices for wireless communication are described. A user equipment (UE) may receive a downlink transmission from a base station, transmit a first stage of feedback for the downlink transmission, identify a condition associated with the downlink transmission, and determine whether to transmit a second stage of feedback for the downlink transmission based at least in part on the identified condition associated with the downlink transmission. The second stage of feedback for the downlink transmission may be transmitted (or not transmitted) based at least in part on the identified condition associated with the downlink transmission.

### CROSS REFERENCES

The present Application for Patent claims priority to U.S. Provisional Patent Application No. 62/160,367 by Chen, et al., entitled “Two-Stage Transmission of Feedback for a Downlink Transmission,” filed May 12, 2015, assigned to the assignee hereof, and expressly incorporated by reference herein.

### BACKGROUND

1. Field of the Disclosure

The following relates generally to wireless communication, and more specifically to two-stage transmission of feedback for a downlink transmission.

2. Description of Related Art

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) or LTE-Advanced (LTE-A) system). A wireless multiple-access communications system may include a number of base stations, each simultaneously supporting communication for multiple communication devices, which may be otherwise known as user equipment (UE).

In some cases, a base station and a UE may operate based on a low latency physical (PHY) layer timing structure. Low latency operations (e.g., operations based on a reduced transmission time interval (TTI)) may enable a reduction in the delay between a transmission and a hybrid automatic repeat request (HARD) response. However, the reduced TTI of the low latency operations may limit the amount of information that can be included in the HARQ response, or conversely, more detailed HARQ responses may consume inordinate portions of the reduced TTIs.

### SUMMARY

The disclosed methods, systems, and devices relate to two-stage transmission of feedback (e.g., hybrid automatic repeat request (HARQ) feedback) for a downlink transmission. In a first stage of feedback for a downlink transmission, limited HARQ information may be transmitted. In some cases, the limited HARQ information may include feedback that is bundled in a time domain, a component carrier (CC) domain, a spatial domain, or a combination thereof. In some cases, the limited HARQ information may include a single bit of information. A second stage of feedback may be transmitted based at least in part on an identified condition associated with the downlink transmission, and in some examples (e.g., when the first stage of bundled feedback includes a single acknowledgement (ACK) bit) may not be transmitted. In some examples, the second stage of feedback may include more detailed HARQ information, and may include less bundled feedback (compared to the limited HARQ information) or no bundled feedback.

A method for wireless communication at a UE is described. The method may include receiving a first downlink transmission from a base station, transmitting a first stage of feedback for the first downlink transmission, identifying a condition associated with the first downlink transmission, and determining whether to transmit a second stage of feedback for the first downlink transmission based on the identified condition associated with the first downlink transmission.

An apparatus for wireless communication at a UE is described. The apparatus may include means for receiving a first downlink transmission from a base station, means for transmitting a first stage of feedback for the first downlink transmission, means for identifying a condition associated with the first downlink transmission, and means for determining whether to transmit a second stage of feedback for the first downlink transmission based on the identified condition associated with the first downlink transmission.

Another apparatus for wireless communication at a UE is described. The apparatus may include a processor, memory in electronic communication with the processor, and instructions stored in the memory. The instructions may be executable by the processor to cause the apparatus to receive a first downlink transmission from a base station, transmit a first stage of feedback for the first downlink transmission, identify a condition associated with the first downlink transmission, and determine whether to transmit a second stage of feedback for the first downlink transmission based on the identified condition associated with the first downlink transmission.

A non-transitory computer-readable medium storing computer-executable code for wireless communication at a UE is described. The code may be executable by a processor to receive a first downlink transmission from a base station, transmit a first stage of feedback for the first downlink transmission, identify a condition associated with the first downlink transmission, and determine whether to transmit a second stage of feedback for the first downlink transmission based on the identified condition associated with the first downlink transmission.

Some examples of the method, apparatuses, or non-transitory computer readable medium may include steps, means, features, or instructions for transmitting the second stage of feedback for the first downlink transmission based on the identified condition associated with the first downlink transmission.

In some examples of the method, apparatuses, or non-transitory computer readable medium, the identified condition may include a trigger received from the base station. In some examples the trigger may indicate whether the second stage of feedback is to be transmitted. Some examples of the method, apparatuses, or non-transitory computer readable medium may include steps, means, features, or instructions for evaluating an information field of a downlink control channel received from the base station to identify the trigger. In some examples the trigger may be a per-UE trigger, a per-cell trigger, or both.

In some examples of the method, apparatuses, or non-transitory computer readable medium, the identified condition may include a sending of a non-acknowledgment (NAK) in the first stage of feedback for the first downlink transmission. In some examples the identified condition may include a condition of a downlink channel used to receive the first downlink transmission. In some examples of the method, apparatuses, or non-transitory computer readable medium, the second stage of feedback may include a first level of detail of feedback information that is greater than a second level of detail of feedback information provided by the first stage of feedback.

Some examples of the method, apparatuses, or non-transitory computer readable medium may include steps, means, features, or instructions for transmitting the first stage of feedback in a first channel, and transmitting the second stage of feedback in a second channel. The first channel may include a shorter transmission time interval (TTI) duration than the second channel.

In some examples of the method, apparatuses, or non-transitory computer readable medium, the first stage of feedback may include bundled feedback in a time-domain, in a CC-domain, in a spatial-domain, or any combination thereof. In some examples of the method, apparatuses, or non-transitory computer readable medium, the second stage of feedback may include separate feedback indications for at least a first portion of the first downlink transmission and a second portion of the first downlink transmission. Some examples of the method, apparatuses, or non-transitory computer readable medium may include steps, means, features, or instructions for receiving the first downlink transmission and the second downlink transmission in at least one codeword in a time instance of a CC, in at least one time instance, in at least one CC, or in any combination thereof. In some examples the bundled feedback of the first stage of feedback may be greater than a bundled feedback of the second stage of feedback.

In some examples of the method, apparatuses, or non-transitory computer readable medium, the first downlink transmission may include a downlink transmission that includes a TTI duration less than a subframe duration, a downlink transmission received over a dedicated radio frequency spectrum band, a downlink transmission received in a shared radio frequency spectrum band, at least two downlink transmissions included in a carrier aggregation operation, or any combination thereof.

Some examples of the method, apparatuses, or non-transitory computer readable medium may include steps, means, features, or instructions for transmitting the second stage of feedback in a later TTI than the first stage of feedback. Some examples of the method, apparatuses, or non-transitory computer readable medium may include steps, means, features, or instructions for transmitting the first stage of feedback without a cyclic redundancy check (CRC), and generating and transmitting a CRC to protect the second stage of feedback.

Some examples of the method, apparatuses, or non-transitory computer readable medium may include steps, means, features, or instructions for transmitting at least one of channel state information (CSI) or a scheduling request (SR) with the second stage of feedback. Some examples of the method, apparatuses, or non-transitory computer readable medium may include steps, means, features, or instructions for transmitting the second stage of feedback for a second downlink transmission while transmitting the first stage of feedback for the first downlink transmission. Some examples of the method, apparatuses, or non-transitory computer readable medium may include steps, means, features, or instructions for combining the second stage of feedback for the second downlink transmission with the first stage of feedback for the first downlink transmission.

Some examples of the method, apparatuses, or non-transitory computer readable medium may include steps, means, features, or instructions for identifying a need to transmit the second stage of feedback for a second downlink transmission, and selecting the second stage of feedback for the second downlink transmission or the first stage of feedback for the first downlink transmission to transmit during a TTI.

In some examples of the method, apparatuses, or non-transitory computer readable medium, the first stage of feedback and the second stage of feedback may be transmitted on a same carrier. In some examples the first stage of feedback and the second stage of feedback may be transmitted on different carriers.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both in organization and method of operation, together with associated advantages, will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communication system, in accordance with aspects of the present disclosure;

FIG. 2 illustrates a portion of an LTE (Long Term Evolution) or LTE-Advanced (LTE-A) radio frame in which low latency operations are supported, in accordance with aspects of the present disclosure;

FIG. 3 illustrates an example of a process flow for a two-stage transmission and reception of feedback for a downlink transmission, in accordance with aspects of the present disclosure;

FIG. 4 illustrates an example of a process flow for a two-stage transmission and reception of feedback for a downlink transmission, in accordance with aspects of the present disclosure;

FIG. 5 shows a diagram of a wireless communications device configured for two-stage transmission of feedback for a downlink transmission, in accordance with aspects of the present disclosure;

FIG. 6 shows a diagram of a wireless communications device configured for two-stage transmission of feedback for a downlink transmission, in accordance with aspects of the present disclosure;

FIG. 7 shows a diagram of a UE wireless communication management manager configured for two-stage transmission of feedback for a downlink transmission, in accordance with aspects of the present disclosure;

FIG. 8 shows a diagram of a UE configured for two-stage transmission of feedback for a downlink transmission, in accordance with aspects of the present disclosure;

FIG. 9 shows a diagram of a wireless communications device configured for two-stage reception of feedback for a downlink transmission, in accordance with aspects of the present disclosure;

FIG. 10 shows a diagram of a wireless communications device configured for two-stage reception of feedback for a downlink transmission, in accordance with aspects of the present disclosure;

FIG. 11 shows a diagram of a base station configured for two-stage reception of feedback for a downlink transmission, in accordance with aspects of the present disclosure;

FIG. 12 shows a flowchart illustrating a method for two-stage transmission of feedback for a downlink transmission, in accordance with aspects of the present disclosure;

FIG. 13 shows a flowchart illustrating a method for two-stage transmission of feedback for a downlink transmission, in accordance with aspects of the present disclosure;

FIG. 14 shows a flowchart illustrating a method for two-stage transmission of feedback for a downlink transmission, in accordance with aspects of the present disclosure; and

FIG. 15 shows a flowchart illustrating a method for two-stage transmission of feedback for a downlink transmission, in accordance with aspects of the present disclosure.

### DETAILED DESCRIPTION

When operating in a low latency environment with a reduced transmission time interval (TTI), the use of a two-stage transmission of feedback (e.g., hybrid automatic repeat request (HARQ) feedback) for a downlink transmission may improve downlink throughput. Limited feedback (e.g., limited HARQ information) may be transmitted in a first stage of feedback for the downlink transmission. In some cases, feedback bundling in a time-domain, a component carrier (CC)-domain, a spatial domain, or a combination thereof may reduce the size of the first stage of feedback (e.g., to one bit (e.g., a single-bit bundled acknowledgement (ACK) corresponding to an acknowledgement of multiple bundled downlink transmissions or multiple bundled portions of a downlink transmission, a single-bit bundled negative acknowledgement (NAK) corresponding to a non-acknowledgment of one or more transmissions of a bundled set of downlink transmissions or one or more portions of a bundled downlink transmission, etc.)). The first stage with limited feedback may be provided more quickly in a low latency environment with a reduced TTI than full feedback (e.g., full HARQ information) may be provided. The second stage of feedback may be transmitted based at least in part on an identified condition associated with the downlink transmission (e.g., if a the feedback or limited HARQ information in the first stage indicates a NAK, which may correspond to a NAK of one of more downlink transmissions of a bundled set of downlink transmissions, etc.), and may not be transmitted in some cases (e.g. if the feedback or limited HARQ information in the first stage indicates an ACK, which may correspond to an acknowledgment of all of the downlink transmissions of a bundled set of downlink transmissions, etc.). In some cases, the second stage of feedback may include more detailed HARQ information (e.g., more detailed than the HARQ information in the first stage, such as HARQ information for each downlink transmission in a bundled set of downlink transmissions, etc.), and may include bundled feedback (e.g., bundled feedback for multiple downlink transmissions, etc.), or no bundled feedback. Thus, overall downlink throughput may be improved through the use of a two-stage transmission of feedback.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

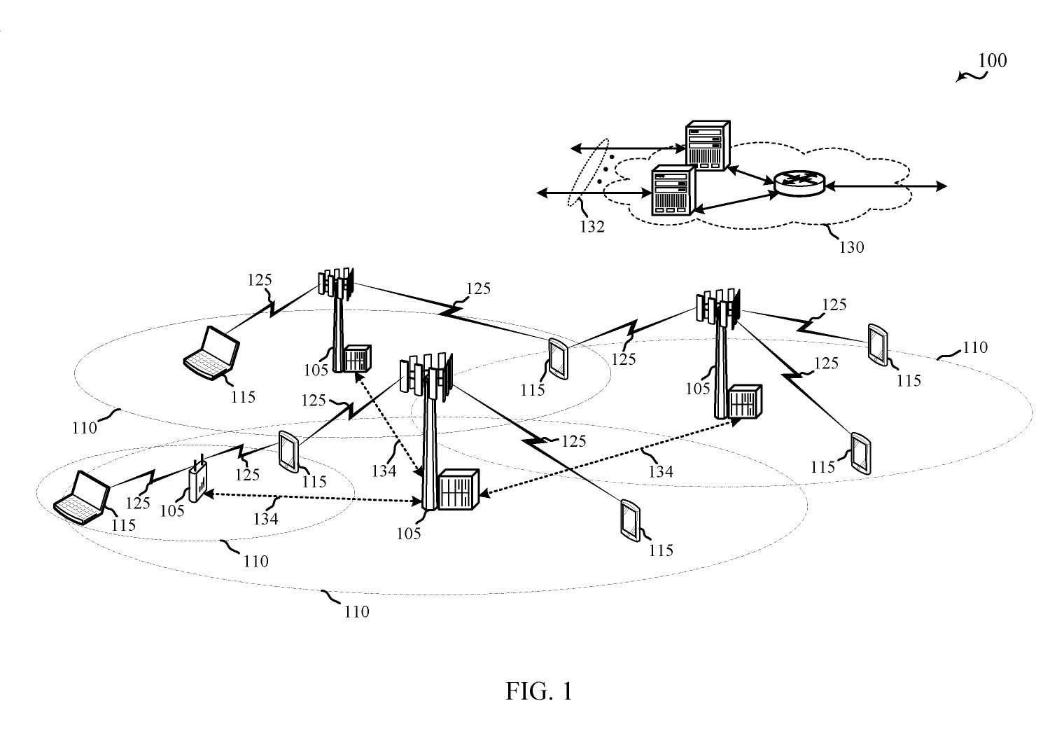

FIG. 1 illustrates an example of a wireless communication system 100, in accordance with aspects of the present disclosure. The wireless communication system 100 may include base stations 105, user equipments (UEs) 115, and a core network 130. The core network 130 may provide user authentication, access authorization, tracking, Internet Protocol (IP) connectivity, and other access, routing, or mobility functions. The base stations 105 may interface with the core network 130 through backhaul links 132 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via at least one base station antenna. Each of the base stations 105 may provide communication coverage for a respective geographic coverage area 110. In some examples, a base station 105 may be referred to as a base transceiver station, a radio base station, an access point, a radio transceiver, a NodeB, an eNB, a Home NodeB, a Home eNodeB, or other suitable terminology. The geographic coverage area 110 for a base station 105 may be divided into sectors making up a portion of the coverage area (not shown). The wireless communication system 100 may include base stations 105 that cover different coverage areas (e.g., macro base stations or small cell base stations). There may be overlapping geographic coverage areas 110 for different technologies.

In some examples, the wireless communication system 100 may include an LTE/LTE-A network. In LTE/LTE-A networks, the term eNB may be used to describe the base stations 105 (or entities including one or more base stations 105). The wireless communication system 100 may be a Heterogeneous LTE/LTE-A network in which different eNBs provide coverage for various geographical regions. For example, each eNB or base station 105 may provide communication coverage for a macro cell, a small cell, or others of cell. The term “cell” can be used to describe a base station, a carrier or component carrier associated with a base station, or a coverage area (e.g., sector, etc.) of a carrier or base station, depending on context.

A macro cell may cover a relatively large geographic area (e.g., several kilometers in radius) and may allow unrestricted access by UEs with service subscriptions with the network provider. A small cell may be a lower-powered base station, as compared with a macro cell that may operate in the same or different (e.g., dedicated, shared, etc.) radio frequency spectrums as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communication system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or physical data convergence protocol (PDCP) layer may be IP-based. A medium access control (MAC) layer may perform packet segmentation and reassembly to communicate over logical channels, and may also perform priority handling and multiplexing of logical channels into transport channels. The MAC layer may also use HARQ to provide retransmission at the MAC layer to improve link efficiency. In the control plane, a Radio Resource Control (RRC) protocol layer may provide establishment, configuration, and maintenance of an RRC connection between a UE 115 and the base stations 105 or core network 130 supporting radio bearers for the user plane data. At the physical (PHY) layer, transport channels may be mapped to physical channels.

The UEs 115 may be dispersed throughout the wireless communication system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a wireless communication device, a personal computer (e.g., a laptop computer, a netbook computer, a tablet computer, etc.), a handheld device, a cellular telephone, a smart phone, a cordless phone, a wireless modem, a wireless local loop (WLL) station, a personal digital assistant (PDA), a digital video recorder (DVR), an internet appliance, a gaming console, an e-reader, etc. A UE may be able to communicate with various base stations and network equipment, including macro eNBs, small cell eNBs, relay base stations, and the like. A UE may also be able to communicate using different radio access technologies (RATs), such as a cellular RAT (e.g., an LTE/LTE-A RAT), a Wi-Fi RAT, or other RATs.

In some examples of the wireless communication system 100, base stations 105 or UEs 115 may include multiple antennas for employing antenna diversity schemes to improve communication quality and reliability between base stations 105 and UEs 115. Additionally or alternatively, base stations 105 or UEs 115 may employ multiple-input, multiple-output (MIMO) techniques that may take advantage of multi-path environments to transmit multiple spatial layers carrying the same or different coded data.

Time intervals in LTE/LTE-A networks may be expressed in multiples of a basic time unit (e.g., the sampling period, Tₛ=1/30,720,000 seconds). Time resources may be organized according to radio frames of length of 10 ms (T_{f}=307200·Ts), which may be identified by a system frame number (SFN) ranging from 0 to 1023. Each frame may include ten 1 ms subframes numbered from 0 to 9. A subframe may be further divided into two 0.5 ms slots, each of which contains 6 or 7 modulation symbol periods (depending on the length of the cyclic prefix prepended to each symbol). Excluding the cyclic prefix, each symbol may contain 2048 sample periods. In some cases the subframe may be the smallest scheduling unit, also known as a transmission time interval (TTI). In other cases, a TTI may be shorter than a subframe or may be dynamically selected (e.g., in short TTI bursts or in selected component carriers using short TTIs).

Base stations 105 and UEs 115 may communicate over the communication links 125 using carriers, which may also be referred to as CCs, layers, channels, etc. The term “component carrier” or CC may refer to each of the multiple carriers utilized by a UE operating in a carrier aggregation (CA) mode, and may be distinct from other portions of system bandwidth. For instance, a CC may be a relatively narrow-bandwidth carrier susceptible of being utilized independently or in combination with other component carriers. Each CC may provide the same capabilities as an isolated carrier based on release 8 or release 9 of the LTE standard. Multiple CCs may be aggregated or utilized concurrently to provide some UEs 115 with greater bandwidth and, e.g., higher data rates. Thus, individual CCs may be backwards compatible with legacy UEs 115 (e.g., UEs 115 implementing LTE release 8 or release 9); while other UEs 115 (e.g., UEs 115 implementing post-release 8/9 LTE versions), may be configured with multiple CCs in a multi-carrier mode. A carrier used for downlink (DL) transmissions may be referred to as a DL CC, and a carrier used for uplink (UL) transmissions may be referred to as an UL CC. A UE 115 may be configured with multiple DL CCs and one or more UL CCs for operation in a multiple-connectivity or carrier aggregation (CA) mode. Each carrier may be used to transmit control information (e.g., reference signals, control channels, etc.), overhead information, data, etc.

A UE 115 may communicate with a single base station 105 utilizing multiple carriers, and may also communicate with multiple base stations simultaneously on different carriers. Each cell of a base station 105 may include an UL CC and a DL CC. The geographic coverage area 110 of each serving cell for a base station 105 may be different (e.g., CCs on different frequency bands may experience different path loss). In some examples, one carrier is designated as the primary carrier, or primary component carrier (PCC), for a UE 115, which may be served by a primary cell (PCell). Primary cells may be semi-statically configured by higher layers (e.g., radio resource control (RRC) layer, etc.) on a per-UE basis. Certain uplink control information (UCI) (e.g., acknowledgement (ACK)/negative acknowledgment (NAK), channel quality indicator (CQI), and scheduling information (e.g., scheduling requests (SRs))) may be transmitted on a physical uplink control channel (PUCCH) carried by the PCell. Additional carriers may be designated as secondary carriers, or secondary component carriers (SCCs), which may be served by secondary cells (SCells). Similar to semi-static configuration of primary cells, secondary cells may also be semi-statically configured on a per-UE basis. In some cases, SCells may not include or be configured to transmit the same control information as the PCell.

In some cases, wireless communication system 100 may utilize one or more enhanced component carriers (eCCs). An eCC may be characterized by one or more features, including flexible bandwidth, different (e.g., reduced) TTIs, modified control channel configuration, and/or use of unlicensed spectrum. In some cases, an eCC may be associated with a CA configuration or a multiple-connectivity configuration (e.g., when multiple serving cells have a suboptimal backhaul link). An eCC may also be configured for use in a dedicated radio frequency spectrum band or a shared radio frequency spectrum band (where more than one operator is licensed to use the spectrum). An eCC characterized by flexible bandwidth may include one or more segments that may be utilized by UEs 115 that do are not capable of monitoring the whole bandwidth or prefer to use a limited bandwidth (e.g., to conserve power).

In some cases, an eCC or other low latency component carrier (CC) may utilize a different TTI length than other CCs, which may include use of a reduced or variable symbol duration as compared with TTIs of the other CCs. The symbol duration may remain the same, in some cases, but each symbol may represent a distinct TTI. In some examples, an eCC may include multiple hierarchical layers associated with the different TTI lengths. For example, TTIs at one hierarchical layer may correspond to uniform 1 ms subframes, whereas in a second layer, variable length TTIs may correspond to bursts of short duration symbol periods. In some cases, a shorter symbol duration may also be associated with increased subcarrier spacing. In conjunction with the reduced TTI length, an eCC may utilize dynamic time division duplex (TDD) operation (e.g., an eCC may switch from downlink (DL) to uplink (UL) operation for short bursts according to dynamic conditions.)

Variable TTIs may be associated with a modified control channel configuration (e.g., an eCC may utilize an enhanced physical downlink control channel (ePDCCH) for DL control information). For example, one or more control channels of an eCC may utilize frequency-division multiplexing (FDM) scheduling to accommodate flexible bandwidth use. Other control channel modifications may include the use of additional control channels (e.g., for evolved multimedia broadcast multicast service (eMBMS) scheduling, or to indicate the length of variable length UL and DL bursts), or control channels transmitted at different intervals. An eCC may also include modified or additional HARQ related control information.

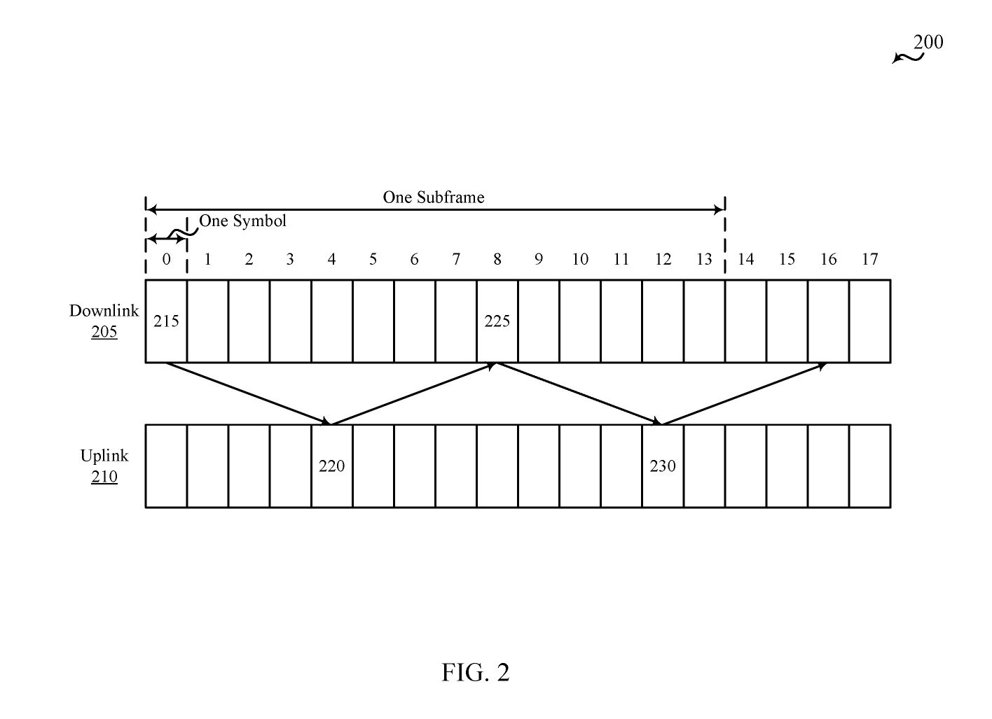

In some examples, wireless communication system 100 may utilize low latency operations. This may be achieved by utilizing a reduced TTI, such as a one symbol period TTI (e.g., approximately 71 μs for a normal cyclic prefix (CP) and approximately 83 μs for an extended CP). This may enable wireless communication system 100 (which may be based on LTE/LTE-A) to achieve one-tenth of the over-the-air HARQ latency of systems that do not utilize low latency operations, for example. That is, the HARQ latency may be approximately 300 μs rather than, for example, approximately 4 ms as in certain LTE-based protocols. Low latency operations may reuse LTE-based numerology to minimize the impact on specifications and improve backward compatibility. For example, a low latency system may use 15 kHz tone spacing and a symbol duration of approximately 71 μs (with a normal CP). This may enable smooth integration of low latency capable devices with devices that are not capable of low latency operation. For example wireless communication system 100 may achieve co-existence within a subframe via resource block level multiplexing. Low latency operations may be utilized for one or both of small cells and macro cells. Low latency operations are further described with reference to FIG. 2.

In some examples, UEs 115 of the wireless communication system 100 may be configured to use a two-stage transmission of feedback (e.g., HARQ feedback) for downlink transmissions received from a base station 105, which may improve downlink throughput of the wireless communication system 100. For example, feedback bundling (e.g., combining feedback for multiple portions of a downlink transmission, combining feedback for multiple downlink transmissions into a single indication, etc.) by a UE 115 in a time-domain, a component carrier (CC)-domain, a spatial domain, or a combination thereof, may reduce the size of the first stage of feedback (e.g., to one bit). Based on an identified condition associated with the downlink transmission, a second stage of feedback may be transmitted by the UE 115. In some examples, the second stage of feedback may include more detailed HARQ information (e.g., more detailed than the HARQ information in the first stage), and may include bundled feedback or no bundled feedback. For example, the second stage of feedback may include separate feedback indications for multiple portions of a downlink transmission, and/or separate feedback indications for multiple downlink transmissions.

FIG. 2 illustrates a portion 200 of an LTE/LTE-A radio frame in which low latency operations are supported, in accordance with aspects of the present disclosure. By way of example, a single downlink CC 205 (or eCC) and a single uplink CC 210 (or eCC) for communication between a base station 105 and a UE 115 are shown. In other examples, multiple downlink or uplink CCs can be used for communication between a base station 105 and a UE 115. The CCs (or eCCs) may be used in a CA or multiple-connectivity mode of operation.

The portion 200 of the LTE/LTE-A radio frame shown in FIG. 2 includes a plurality of symbol periods (e.g., orthogonal frequency division multiplexed (OFDM) symbol periods) numbered 0 through 17. A group of 14 symbol periods, with a normal CP, may define a subframe of the LTE/LTE-A radio frame according to some LTE-based protocols. However, in accordance with low latency operation, each symbol period may define a different low latency TTI. In some examples, the low latency TTIs may be associated with eight HARQ processes (e.g., in a frequency division duplexing (FDD) mode). In accordance with one HARQ process, a downlink transmission 215 in a low latency physical downlink control channel (uPDCCH) or low latency physical downlink shared channel (uPDSCH) may be acknowledged (ACK'd) or non-acknowledged (NAK'd) four low latency TTIs later in a first HARQ response transmission 220, in a low latency physical uplink control channel (uPUCCH) or low latency physical uplink shared channel (uPUSCH). A retransmission 225 of the downlink transmission, when needed, may be made four low latency TTIs after a base station receives a NAK, which may then be followed by a second HARQ response transmission 230.

Providing HARQ feedback may be more difficult when a TTI duration is reduced, such as for a low-latency TTI. For example, the number of HARQ bits for a UE may depend on the number of low latency CCs configured for the UE, a number of downlink transmissions mapped to an uplink transmission for HARQ feedback, as well as the downlink transmission mode configured for each CC (e.g., the HARQ feedback for five low latency CCs, each operating in a downlink MIMO transmission mode, may use ten bits, which can represent a significant portion of a uPUCCH). Using a significant portion of an uPUCCH can also be a poor use of resources given that HARQ feedback for downlink transmissions is sometimes not useful. In some cases, bundling of feedback may be used to reduce the size of a HARQ payload. For example, when each of five CCs is operated in a MIMO mode, HARQ bundling may be performed in both a spatial domain and a CC-domain, thereby reducing the size of the HARQ payload from ten bits to one bit. However, such bundling can negatively impact downlink throughput (especially when bundling is used in the CC-domain). Thus, a two-stage transmission of feedback for a downlink transmission may be beneficial in some examples.

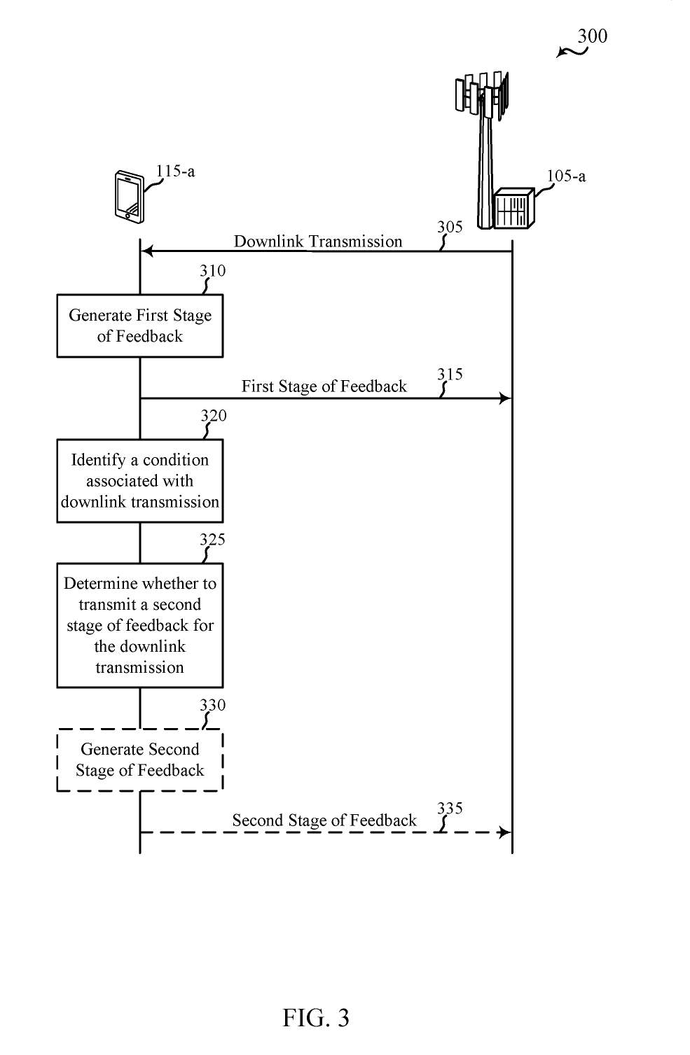

FIG. 3 illustrates an example of a process flow 300 for a two-stage transmission and reception of feedback for a downlink transmission, in accordance with aspects of the present disclosure. Process flow 300 may include a UE 115-a and base station 105-a, which may be examples of UEs 115 and base stations 105 described with reference to FIG. 1.

At 305, base station 105-a may transmit a downlink transmission to UE 115-a. The downlink transmission of 305 may include a single downlink transmission or multiple downlink transmissions (e.g., the downlink transmission of 305 may include one or more portions, etc.). In some examples, the downlink transmission may be transmitted or received in a codeword in a time instance of a CC, in a time instance, in a CC, or in a combination thereof. Different downlink transmissions received at 305 may be received in the same or different codewords, time instances, CCs, or combination thereof. In some examples, a downlink transmission may include a downlink transmission having a TTI duration less than a subframe duration, a downlink transmission transmitted or received over a dedicated radio frequency spectrum band, a downlink transmission transmitted or received in a shared radio frequency spectrum band, at least two downlink transmissions included in a carrier aggregation operation, or a combination thereof.

At 310, UE 115-a may generate a first stage of feedback for the downlink transmission. For example, the first stage of feedback may be based at least in part on whether the downlink transmission is fully received and/or decoded (e.g., whether each portion of the downlink transmission of 305 is fully received and/or decoded, whether each of a plurality of transmissions of the downlink transmission of 305 is fully received and/or decoded, etc.). At 315, the first stage of feedback may be transmitted to base station 105-a.

At 320, UE 115-a may identify a condition associated with the downlink transmission. At 325, UE 115-a may determine whether to transmit a second stage of feedback for the downlink transmission based at least in part on the identified condition. At 330, and when indicated by the determination at 325, UE 115-a may generate the second stage of feedback. UE 115-a may transmit the second stage of feedback to base station 105-a at 335. In some examples, the second stage of feedback may be transmitted in a later TTI than the first stage of feedback. In some cases (e.g., when indicated by the determination at 325), UE 115-a may refrain from generating or transmitting the second stage of feedback.

In some examples, the second stage of feedback may include a level of detail of feedback information that is greater than a level of detail of feedback information provided by the first stage of feedback. For example, the first stage of feedback may include HARQ feedback with limited HARQ information, and the second stage of feedback may include HARQ feedback with more detailed HARQ information. The limited HARQ information may be selected such that the first stage of feedback may be transmitted more quickly than the second stage of feedback. In some examples, the limited HARQ information may include one or two bits of information, and may include bundled feedback (e.g., a bundled indication providing feedback for at least a first downlink transmission and a second downlink transmission included in the downlink transmission transmitted at 305, feedback for a first portion and a second portion of the downlink transmission transmitted at 305, etc.). The bundled feedback may be bundled in a time-domain, in a CC-domain, in a spatial domain, or in a combination thereof. When the limited HARQ information includes one bit of information, the one bit of information may indicate an ACK when all downlink transmissions or portions of transmissions included in the downlink transmission transmitted at 305 are received and decoded, and a NAK when any downlink transmission included in the downlink transmission transmitted at 305 is not received or decoded.

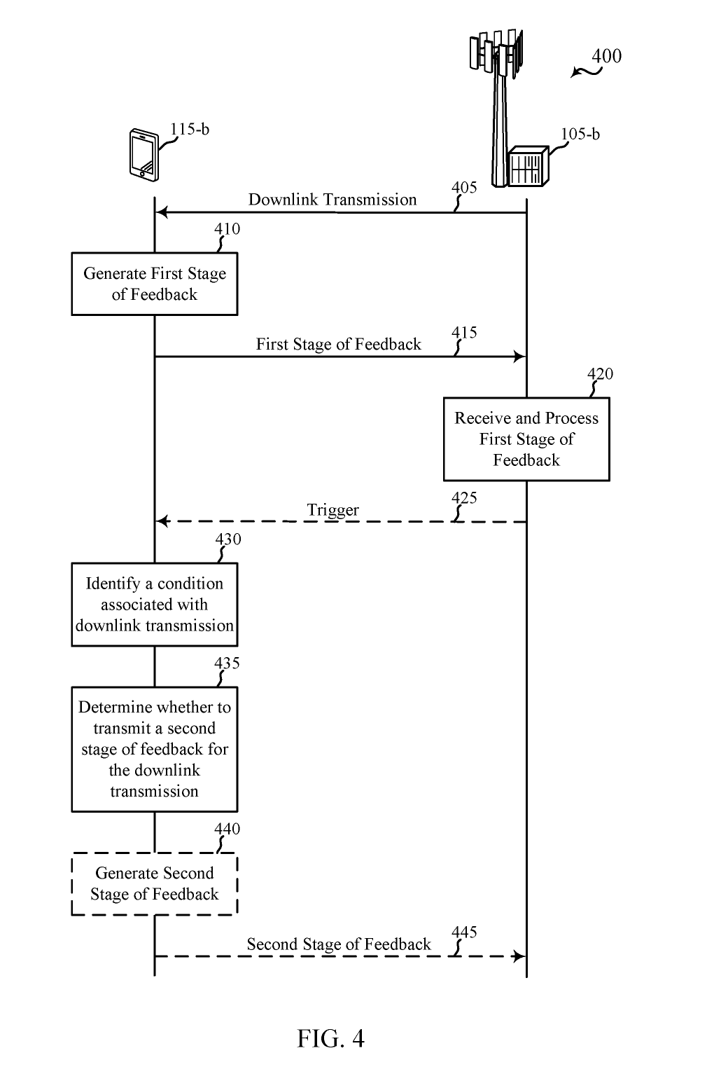

The limited HARQ information (or first stage of feedback) may provide quick but limited HARQ information that indicates to base station 105-a whether one or more HARQ re-transmissions need to be performed for the downlink transmission transmitted at 305. In some examples, when base station 105-a receives an ACK in the first stage of feedback, base station 105-a may proceed with new transmissions. When base station 105-a receives a NAK in the first stage of feedback, base station 105-a may trigger a transmission of the second stage of feedback, or wait for the second stage of feedback, as described, for example, with reference to FIG. 4, or perform HARQ re-transmissions for some or all of the corresponding downlink transmissions.

In some examples (e.g., when the first stage of feedback includes bundled feedback), the second stage of feedback may include separate feedback indications for at least two downlink transmissions (e.g., for at least a first downlink transmission and a second downlink transmission, a first portion and a second portion of a downlink transmission, etc.). In some examples, the second stage of feedback may include bundled feedback, but the bundled feedback of the first stage of feedback may be greater than the bundled feedback of the second stage of feedback (e.g., the second stage of feedback may contain less or more loosely bundled feedback (e.g., the second stage of feedback may include spatial domain bundled feedback, but not time-domain and not CC-domain bundled feedback)). In other examples, the second stage of feedback may not include bundled feedback. In some examples, CSI or a SR may be transmitted with the second stage of feedback.

The first stage of feedback and second stage of feedback (when transmitted) may be transmitted on the same or different carriers. In some examples, the first stage of feedback may be transmitted in a first channel (e.g., in response to downlink scheduling), and the second stage of feedback may be transmitted in a second channel. The first channel may include a shorter TTI duration than the second channel, and in some examples may include a uPUCCH or uPUSCH. The second channel may include, for example, a PUCCH or physical uplink shared channel (PUSCH).

FIG. 4 illustrates an example of a process flow 400 for a two-stage transmission and reception of feedback for a downlink transmission, in accordance with aspects of the present disclosure. Process flow 400 may include a UE 115-b, which may be an example of a UE 115 described with reference to FIG. 1, and a base station 105-b, which may be an example of a base station 105 described with reference to FIG. 1.

At 405, base station 105-b may transmit a downlink transmission to UE 115-b. The downlink transmission of 405 may include a single downlink transmission or multiple downlink transmissions. In some examples, the downlink transmission may be transmitted or received in a codeword in a time instance of a CC, in a time instance, in a CC, or in a combination thereof. Different downlink transmissions received at 405 may be received in the same or different codewords, time instances, CCs, or in a combination thereof. In some examples, a downlink transmission may include a downlink transmission having a TTI duration less than a subframe duration, a downlink transmission transmitted or received over a dedicated radio frequency spectrum band, a downlink transmission transmitted or received in a shared radio frequency spectrum band, at least two downlink transmissions included in a carrier aggregation operation, or a combination thereof.

At 410, UE 115-b may generate a first stage of feedback for the downlink transmission. The first stage of feedback may be based at least in part on whether the downlink transmission is fully received and/or decoded. At 415, the first stage of feedback may be transmitted to base station 105-b.

At 420, base station 105-b may receive and process the first stage of feedback, and optionally determine whether the UE 115-b should transmit a second stage of feedback for the downlink transmission. In some examples, base station 105-b may proactively determine whether the UE 115-b should transmit the second stage of feedback (e.g., base station 105-b may make the determination independently of receiving the first stage of feedback). In these examples, the determination at 420 may be made after transmission of the downlink transmission at 405, as shown, or before or during transmission of the downlink transmission (not shown). In other examples, base station 105-b may reactively determine whether the UE 115-b should transmit the second stage of feedback (e.g., based at least in part on the first stage of feedback received at 415). At 425, and upon determining the second stage of feedback is to be transmitted, base station 105-b may transmit to UE 115-b a trigger indicating that the second stage of feedback is to be transmitted. Alternatively, base station 105-b may transmit a trigger at 425 regardless of the determination, and may set a state or value of the trigger based at least in part on the determination. The timing of the trigger may be as shown in FIG. 4, or may occur at other times before, during, or after transmission of the downlink transmission at 405.

At 430, UE 115-b may identify a condition associated with the first downlink transmission. The condition may include, for example, a trigger received from the base station at 425, a sending of a NAK in the first stage of feedback for the first downlink transmission at 415, or a condition of a downlink channel used to receive the downlink transmission at 405. When the condition includes a trigger received from base station 105-b, identifying the condition may include evaluating an information field of a downlink control channel received from base station 105-b.

At 435, UE 115-b may determine whether to transmit a second stage of feedback for the downlink transmission based at least in part on the condition. The determination may include, for example, determining whether the trigger has been received from the base station or whether a value of the trigger indicates the second stage of feedback is to be transmitted. When the trigger is received or indicates the second stage of feedback is to be transmitted, the second stage of feedback may be transmitted at 445. The determination may additionally or alternatively include determining whether a NAK was sent in the first stage of feedback for the downlink transmission. If it is determined that a NAK was sent, the second stage of feedback may be transmitted. Still further, the determination may additionally or alternatively include determining whether a condition of a downlink channel used to receive the downlink transmission satisfies a threshold (e.g., the UE 115-b may determine whether the condition of the downlink channel is poor). When the condition satisfies the threshold, the second stage of feedback may be transmitted.

At 440, and when indicated by the determination at 435, UE 115-b may generate the second stage of feedback. UE 115-b may transmit the second stage of feedback to base station 105-b at 445. In some examples, the second stage of feedback may be transmitted in a later TTI than the first stage of feedback. In some cases (e.g., when indicated by the determination at 435), UE 115-b may refrain from generating or transmitting the second stage of feedback.

In some examples, a CRC to protect the second stage of feedback may be generated at 440, and transmitted with the second stage of feedback at 445. In some examples, a CRC may not be generated to protect the first stage of feedback, to keep the size of the first stage of feedback small.

In various examples of the process flow 300 or the process flow 400, a UE may have the option of transmitting a first stage of feedback for a first downlink transmission in parallel with a second stage of feedback for a second downlink transmission. In some examples, the second stage of feedback for the second downlink transmission may be transmitted while transmitting the first stage of feedback for the first downlink transmission. In some examples, the second stage of feedback for the second downlink transmission may be combined with the first stage of feedback for the first downlink transmission. In other examples, the UE may select the first stage of feedback for the first downlink transmission or the second stage of feedback for the second downlink transmission to transmit during a TTI.

In some examples, the two-stage transmission of feedback by a UE, as described with reference to FIGS. 1-4, may be enabled (e.g., by a base station) on a per-UE basis or per-cell basis. When enabled on a per-UE basis, the enablement may in some examples be based, at least in part, on the configuration of a UE. For example, when one low latency CC is configured for a UE and the UE is experiencing good channel conditions, the first stage of feedback may be sufficient (e.g., the second stage of feedback may not be enabled). When a UE is experiencing poor channel conditions, the second stage of feedback may be sufficient (e.g., the first stage of feedback may not be enabled). When a UE is configured with multiple CCs or when a UE needs to provide feedback for multiple symbols in one CC (e.g., in a TDD-like operation when multiple downlink transmissions in different time instances are mapped to the same uplink time instance for HARQ feedback), and when the UE is experiencing adequate channel conditions, two-stage transmission of feedback may be enabled.

In some examples, the two-stage-transmission of feedback by a UE, as described with reference to FIGS. 1-4, may have different feedback details for different UEs and/or for different configurations. As an example, a first UE may have a 1-bit first stage feedback and a 16-bit second stage feedback, while a second may have a 2-bit first stage feedback and a 40-bit second stage feedback. A UE may be configured to have a 1-bit first stage feedback and a 16-bit second stage feedback in one configuration, and it may also be configured to have a 2-bit first stage feedback and a 40-bit second stage feedback in another configuration.

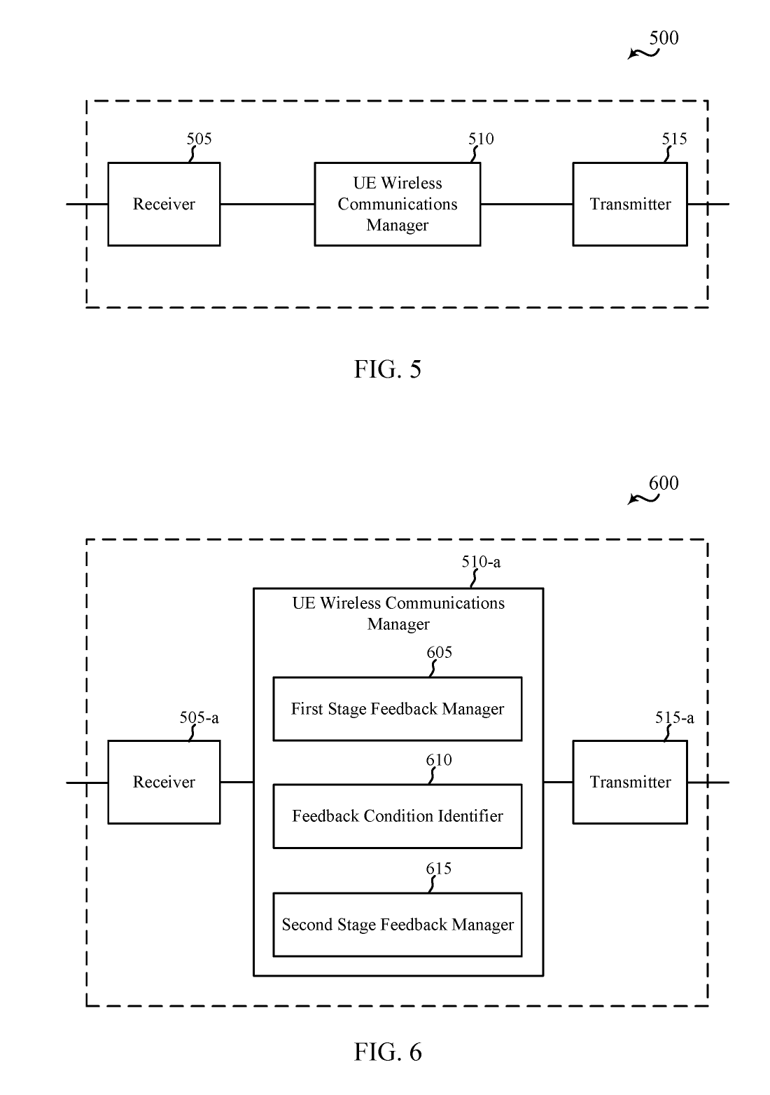

FIG. 5 shows a diagram of a wireless communications device 500 configured for two-stage transmission of feedback for a downlink transmission, in accordance with aspects of the present disclosure. Wireless communications device 500 may be an example of aspects of a UE 115 as described with reference to FIGS. 1-4. Wireless communications device 500 may include a receiver 505, a UE wireless communications manager 510, and a transmitter 515. Wireless communications device 500 may also include a processor and memory. Each of these components may be in communication with each other.

The receiver 505 may receive information such as packets, user data, or control information associated with various information channels (e.g., control channels, data channels, and information related to low latency operation with different HARQ timing, etc.). Information may be passed on to UE wireless communications manager 510, and to other components of wireless communications device 500. The receiver 505 may include a single antenna, or it may include a plurality of antennas. In some cases the receiver 505 may receive, from a base station (e.g., a serving cell), downlink transmissions or a trigger indicating whether second stage feedback is to be transmitted.

The UE wireless communications manager 510 may be used to generate and transmit (e.g., in cooperation with the transmitter 515) a first stage of feedback for a downlink transmission received via the receiver 505, identify a condition associated with the downlink transmission, determine whether to transmit a second stage of feedback for the downlink transmission based at least in part on the identified condition, and when indicated, transmit the second stage of feedback for the downlink transmission (e.g., in cooperation with the transmitter 515), as described with reference to FIGS. 3-4.

In some examples, a downlink transmission may be received in a codeword in a time instance of a CC, in a time instance, in a CC, or in any combination thereof. Different downlink transmissions may be received in the same or different codewords, time instances, CCs, or any combination thereof. In some examples, a downlink transmission may include a downlink transmission having a TTI duration less than a subframe duration, a downlink transmission received over a dedicated radio frequency spectrum band, a downlink transmission received in a shared radio frequency spectrum band, at least two downlink transmissions included in a carrier aggregation operation, or a combination thereof.

The transmitter 515 may transmit signals received from other components of wireless communications device 500. In some examples, the transmitter 515 may be collocated with the receiver 505 in a transceiver module. The transmitter 515 may include a single antenna, or it may include a plurality of antennas. In some cases, the transmitter 515 may transmit, to a base station, a first stage of feedback or a second stage of feedback for a downlink transmission.

FIG. 6 shows a diagram of a wireless communications device 600 configured for two-stage transmission of feedback for a downlink transmission, in accordance with aspects of the present disclosure. Wireless communications device 600 may be an example of aspects of the wireless communications device 500 or a UE 115 described with reference to FIGS. 1-5. Wireless communications device 600 may include a receiver 505-a, a UE wireless communications manager 510-a, and a transmitter 515-a. Wireless communications device 600 may also include a processor and memory. Each of these components may be in communication with each other.

The receiver 505-a, UE wireless communications manager 510-a, and transmitter 515-a may be respective examples of the receiver 505, UE wireless communications manager 510, and transmitter 515 described with reference to FIG. 5. The UE wireless communications manager 510-a may include a first stage feedback manager 605, a feedback condition identifier 610, and a second stage feedback manager 615.

The first stage feedback manager 605 may be used to generate and transmit (e.g., in cooperation with the transmitter 515-a) a first stage of feedback for a downlink transmission received via the receiver 505, as described with reference to FIGS. 3-4. In some examples, the first stage of feedback may include bundled feedback (e.g., feedback for at least a first downlink transmission and a second downlink transmission included in the downlink transmission). The bundled feedback may be bundled in a time-domain, in a CC-domain, in a spatial-domain, or in a combination thereof.

The feedback condition identifier 610 may be used to identify a condition associated with the downlink transmission. The condition may include, for example, a trigger received from a base station, a sending of a NAK in a first stage of feedback, or a condition of a downlink channel used to receive a downlink transmission. When the condition includes a trigger received from a base station, identifying the condition may include evaluating an information field of a downlink control channel received from the base station.

The second stage feedback manager 615 may be used to determine whether to transmit a second stage of feedback for the downlink transmission based at least in part on the identified condition, and when indicated, transmit the second stage of feedback for the downlink transmission (e.g., in cooperation with the transmitter 515-a). In some examples, the second stage of feedback may include a level of detail of feedback information that is greater than a level of detail of feedback information provided by the first stage of feedback. In some examples (e.g., when the first stage of feedback includes bundled feedback), the second stage of feedback may include separate feedback indications for at least two downlink transmissions (e.g., for a first downlink transmission and a second downlink transmission, for a first portion and a second portion of a downlink transmission, etc.). In some examples, the second stage of feedback may include bundled feedback, but the bundled feedback of the first stage of feedback may be greater than the bundled feedback of the second stage of feedback (e.g., the second stage of feedback may contain less or more loosely bundled feedback). In other examples, the second stage of feedback may not include bundled feedback.

The first stage of feedback and the second stage of feedback may be transmitted via the transmitter 515-a. In some examples, the first stage of feedback and the second stage of feedback may be transmitted on a same carrier. In other examples, the first stage of feedback and the second stage of feedback may be transmitted on different carriers.

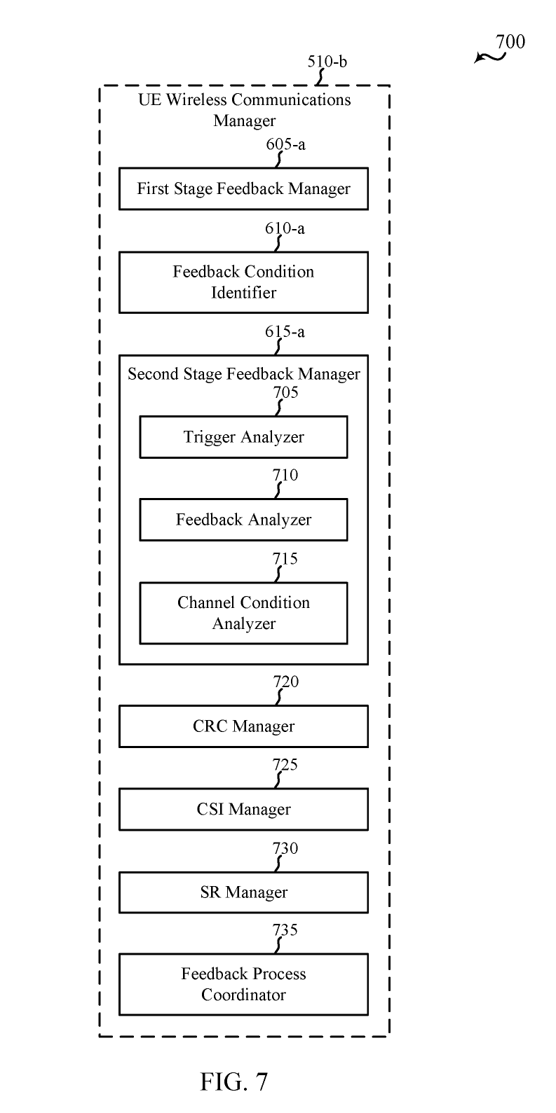

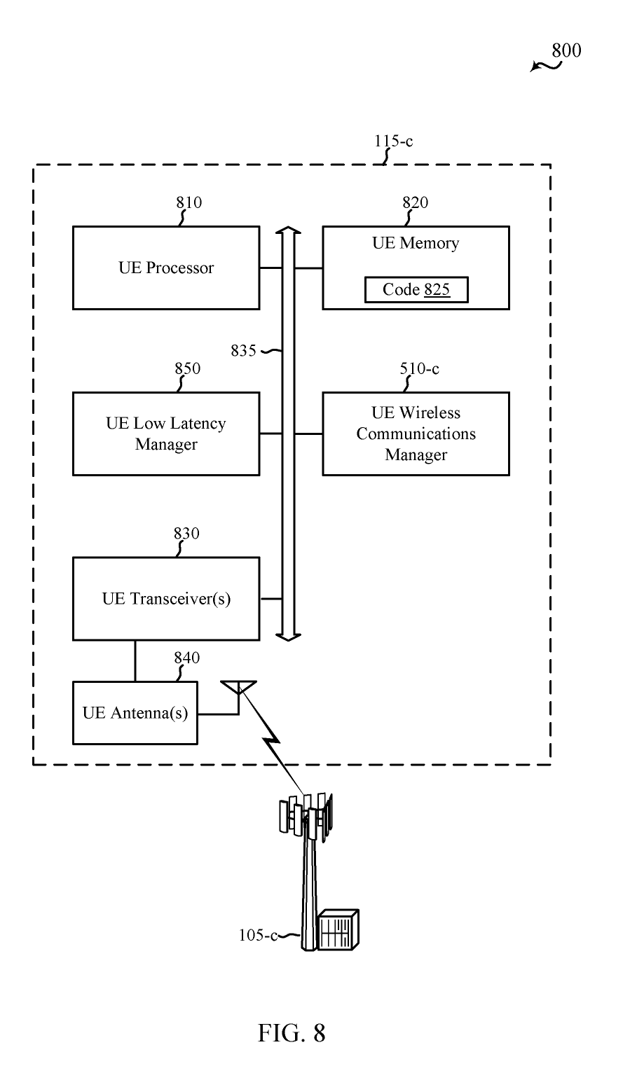

FIG. 7 shows a diagram 700 of a UE wireless communications manager 510-b configured for two-stage transmission of feedback for a downlink transmission, in accordance with aspects of the present disclosure. The UE wireless communications manager 510-b may be an example of aspects of UE wireless communications managers 510, and may be a component of the wireless communications devices 500 or 600, as described with reference to FIG. 5 or 6. The UE wireless communications manager 510-b may include a first stage feedback manager 605-a, a feedback condition identifier 610-a, and a second stage feedback manager 615-a. Each of these components may perform the functions described with reference to FIG. 6. The UE wireless communications manager 510-b may also include a CRC manager 720, a CSI manager 725, a SR manager 730, and/or a feedback process coordinator 735.

The first stage feedback manager 605-a may be used to generate and transmit a first stage of feedback for a downlink transmission, as described with reference to FIGS. 3-4. In some examples, the first stage of feedback may be transmitted without a CRC.

The feedback condition identifier 610-a may be used to identify a condition associated with the downlink transmission. The condition may include, for example, a trigger received from a base station indicating whether the second stage of feedback is to be transmitted, a sending of a NAK in a first stage of feedback, or a condition of a downlink channel used to receive a downlink transmission. When the condition includes a trigger received from a base station, identifying the condition may include evaluating an information field of a downlink control channel received from the base station.

The second stage feedback manager 615-a may be used to determine whether to transmit a second stage of feedback for the downlink transmission based at least in part on the identified condition, and when indicated, transmit the second stage of feedback for the downlink transmission. The second stage feedback manager 615-a may include one or more of a trigger analyzer 705, a feedback analyzer 710, or a channel condition analyzer 715, each of which may receive and evaluate a condition identified by the feedback condition identifier 610-a.

The second stage feedback manager 615-a may determine to transmit the second stage of feedback when the trigger analyzer 705 determines that a trigger has been received from a base station or that a value of a received trigger indicates the second stage of feedback is to be transmitted. The second stage feedback manager 615-a may also determine to transmit the second stage of feedback when the feedback analyzer 710 determines a NAK was sent in the first stage of feedback. The second stage feedback manager 615-a may also determine to transmit the second stage of feedback when the channel condition analyzer 715 determines a condition of a downlink channel used to receive the downlink transmission (for which the second stage of feedback is being transmitted) satisfies a threshold (e.g., when the channel condition analyzer 715 determines the condition of the downlink channel is poor, etc.). The second stage feedback manager 615-a may otherwise determine to refrain from transmitting the second stage of feedback. In some examples, the second stage feedback manager 615-a may employ the CRC manager 720 to generate a CRC to protect the second stage of feedback. In some examples, the second stage feedback manager 615-a may transmit the second stage of feedback with a CSI or a SR received from the CSI manager 725 or SR manager 730, respectively.

In some examples of the UE wireless communications manager 510-b, the first stage feedback manager 605-a may configure the transmission of the first stage of feedback in a first channel, and the second stage feedback manager 615-a may configure the transmission of the second stage of feedback in a second channel. The first channel may include a shorter TTI duration than the second channel. In some examples of the UE wireless communications manager 510-b, the second stage feedback manager 615-a may configure the transmission of the second stage of feedback in a later TTI than the first stage of feedback.

The feedback process coordinator 735 may be used to coordinate overlapping transmissions of a first stage of feedback for a first downlink transmission and a second stage of feedback for a second downlink transmission. In some examples, the feedback process coordinator 735 may provide for the second stage feedback manager 615-a to configure the transmission of the second stage of feedback for the second downlink transmission while the first stage feedback manager 605-a configures the transmission of the first stage of feedback for the first downlink transmission. In some examples, the feedback process coordinator 735 may combine the second stage of feedback for the second downlink transmission with the first stage of feedback for the first downlink transmission. In other examples, the feedback process coordinator 735 may select the first stage of feedback for the first downlink transmission or the second stage of feedback for the second downlink transmission to transmit during a TTI.

The components of wireless communications device 500, wireless communications device 600, and the UE wireless communications managers 510 described with reference to FIG. 5, 6, or 7 may, individually or collectively, be implemented with at least one application specific integrated circuit (ASIC) adapted to perform some or all of the applicable functions in hardware. Alternatively, the functions may be performed by one or more other processing units (or cores), on at least one integrated circuit (IC). In other examples, other types of integrated circuits may be used (e.g., structured/platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

FIG. 8 shows a diagram 800 of a UE 115-c configured for two-stage transmission of feedback for a downlink transmission, in accordance with aspects of the present disclosure. The UE 115-c may have various configurations and may be a wireless communication device, a personal computer (e.g., a laptop computer, a netbook computer, a tablet computer, etc.), a handheld device, a cellular telephone, a smart phone, a cordless phone, a wireless modem, a wireless local loop (WLL) station, a personal digital assistant (PDA), a digital video recorder (DVR), an internet appliance, a gaming console, an e-reader, etc. The UE 115-c may, in some examples, have an internal power supply (not shown), such as a small battery, to facilitate mobile operation. In some examples, the UE 115-c may be an example of aspects of one or more of the UEs 115, wireless communications device 500, or wireless communications device 600 described with reference to FIGS. 1-7. The UE 115-c may be configured to implement at least some of the UE or wireless communications device features and functions described with reference to FIGS. 1-7.

The UE 115-c may include a UE processor 810, UE memory 820, at least one UE transceiver (represented by UE transceiver(s) 830), at least one UE antenna (represented by UE antenna(s) 840), a UE low latency manager 850, or a UE wireless communications manager 510-c. Each of these components may be in communication with each other, directly or indirectly, over one or more buses 835.

The UE memory 820 may include random access memory (RAM) or read-only memory (ROM). The UE memory 820 may store computer-readable, computer-executable software/firmware code 825 containing instructions that are configured to, when executed, cause the UE 115-c to perform various functions described herein related to wireless communication, including, for example, the transmission of two-stage feedback for a downlink transmission, as described with reference to FIGS. 1-7. Alternatively, the code 825 may not be directly executable by the UE processor 810, but may be otherwise configured to cause the UE 115-c (e.g., when compiled and executed) to perform various of the functions described herein.

The UE processor 810 may include an intelligent hardware device, e.g., a central processing unit (CPU), a microcontroller, an ASIC, etc. The UE processor 810 may process information received through the UE transceiver(s) 830 or information to be sent to the UE transceiver(s) 830 for transmission through the UE antenna(s) 840. The UE processor 810 may handle, alone or in connection with the UE wireless communications manager 510-c, various aspects of communicating over (or managing communications over) a radio frequency spectrum band.

The UE transceiver(s) 830 may include a modem configured to modulate packets and provide the modulated packets to the UE antenna(s) 840 for transmission, and to demodulate packets received from the UE antenna(s) 840. The UE transceiver(s) 830 may, in some examples, be implemented as one or more UE transmitters and one or more separate UE receivers. The UE transceiver(s) 830 may support communications over one or more wireless channels. The UE transceiver(s) 830 may be configured to communicate bi-directionally, via the UE antenna(s) 840, with one or more base stations or other devices, such as one or more of the base stations 105 (e.g., base station 105-c) described with reference to FIGS. 1-4. While the UE 115-c may include a single UE antenna, there may be examples in which the UE 115-c may include multiple UE antennas 840.

The UE low latency manager 850 may enable the UE 115-c to communicate using a reduced TTI and HARQ latency, as described herein (e.g., with reference to FIGS. 1-2).

The UE wireless communications manager 510-c may be configured to perform or control some or all of the UE or device features or functions described with reference to FIGS. 1-7 related to wireless communication over a radio frequency spectrum band. The UE wireless communications manager 510-c, or portions of it, may include a processor, or some or all of the functions of the UE wireless communications manager 510-c may be performed by the UE processor 810 or in connection with the UE processor 810. In some examples, the UE wireless communications manager 510-c may be an example of a UE wireless communications manager 510 described with reference to FIGS. 5-7.

FIG. 9 shows a diagram of a wireless communications device 900 configured for two-stage reception of feedback for a downlink transmission, in accordance with aspects of the present disclosure. Wireless communications device 900 may be an example of aspects of a base station 105 described with reference to FIGS. 1-4. Wireless communications device 900 may include a receiver 905, a base station wireless communications manager 910, and a transmitter 915. Wireless communications device 900 may also include a processor and memory. Each of these components may be in communication with each other.

The receiver 905 may receive information such as packets, user data, or control information associated with various information channels (e.g., control channels, data channels, and information related to low latency operation with different HARQ timing, etc.). Information may be passed on to base station wireless communications manager 910, and to other components of wireless communications device 900. The receiver 905 may include a single antenna, or it may include a plurality of antennas. In some cases, the receiver 905 may receive, from a UE, a first stage of feedback or a second stage of feedback for a downlink transmission.

The base station wireless communications manager 910 may receive and process a first stage of feedback and/or a second stage of feedback for a downlink transmission transmitted via the transmitter 915, as described with reference to FIGS. 1-4. The first stage of feedback or second stage of feedback may be received via the receiver 905. In some examples, the base station wireless communications manager 910 may be used to proactively (e.g., independently of receiving the first stage of feedback) or reactively (e.g., based at least in part on receiving the first stage of feedback) transmit a trigger indicating whether the second stage of feedback is to be transmitted.

The transmitter 915 may transmit signals received from other components of wireless communications device 900. In some examples, the transmitter 915 may be collocated with the receiver 505 in a transceiver module. The transmitter 915 may include a single antenna, or it may include a plurality of antennas. The transmitter 915 may transmit downlink transmissions to one or more UEs served by the wireless communications device 900. In some cases, the transmitter 915 may transmit, to a UE, multiple UEs, or all of the UEs in a cell, a trigger indicating whether second stage feedback is to be transmitted.

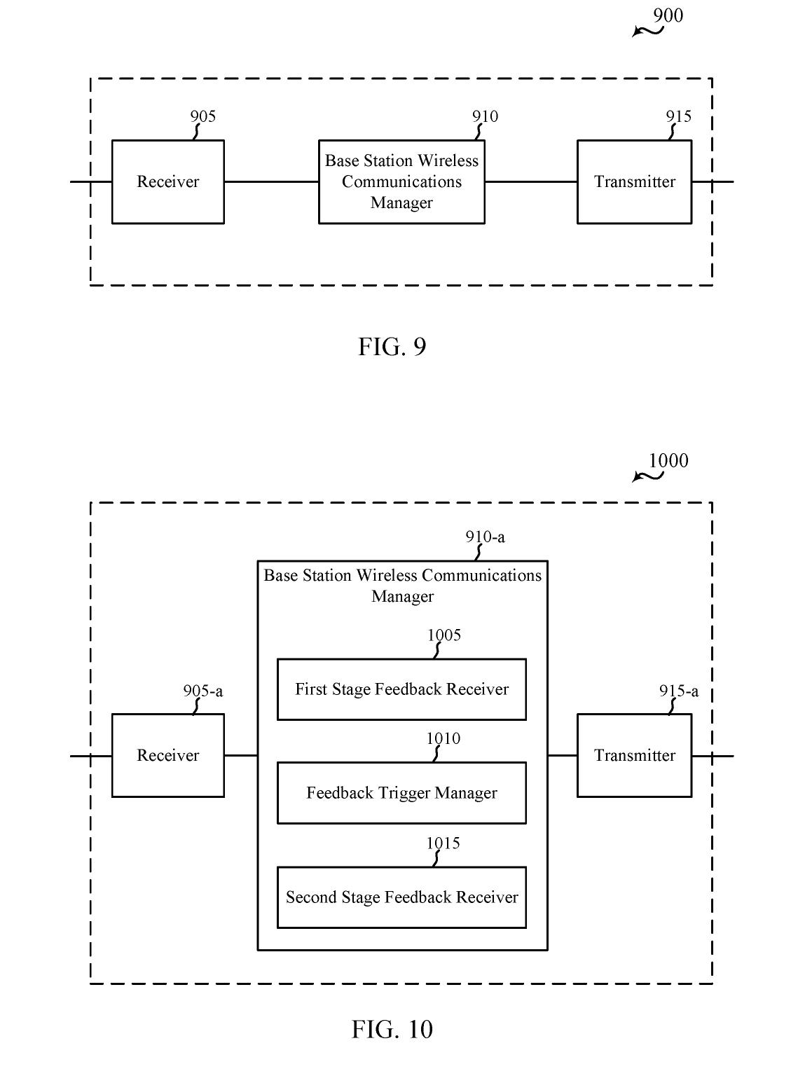

FIG. 10 shows a diagram of a wireless communications device 1000 configured for two-stage reception of feedback for a downlink transmission, in accordance with aspects of the present disclosure. Wireless communications device 1000 may be an example of aspects of the wireless communications device 900 or a base station 105 described with reference to FIGS. 1-4 or FIG. 9. Wireless communications device 1000 may include a receiver 905-a, a base station wireless communications manager 910-a, and a transmitter 915-a. Wireless communications device 1000 may also include a processor and memory. Each of these components may be in communication with each other.

The receiver 905-a, base station wireless communications manager 910-a, and transmitter 915-a may be respective examples of the receiver 905, base station wireless communications manager 910, and transmitter 915 described with reference to FIG. 9. The base station wireless communications manager 910-a may include a first stage feedback receiver 1005, a feedback trigger manager 1010, and a second stage feedback receiver 1015.

The first stage feedback receiver 1005 may be used to receive (e.g., in cooperation with the receiver 905-a) and interpret a first stage of feedback for a downlink transmission, as described with reference to FIGS. 1-4. In some examples, the first stage of feedback may include bundled feedback (e.g., feedback for at least a first downlink transmission and a second downlink transmission included in the downlink transmission). The bundled feedback may be bundled in a time-domain, in a CC-domain, in a spatial-domain, or in a combination thereof.

The feedback trigger manager 1010 may be used to determine whether a UE should transmit a second stage of feedback for the downlink transmission. In some examples the feedback trigger manager 1010 may proactively determine whether a UE should transmit the second stage of feedback (e.g., may make the determination independently of receiving the first stage of feedback). In these examples, the determination may be made before, during, or after a transmission of a downlink transmission. In other examples, the feedback trigger manager 1010 may reactively determine whether a UE should transmit a second stage of feedback (e.g., based at least in part on a first stage of feedback received by the first stage feedback receiver 1005). The feedback trigger manager 1010, in coordination with the transmitter 915-a, may transmit a trigger indicating that a second stage of feedback is to be transmitted. Additionally or alternatively, the feedback trigger manager 1010 and the transmitter 915-a may transmit a trigger regardless of the determination, and may set a state or value of the trigger based at least in part on the determination.

The second stage feedback receiver 1015 may be used to receive (e.g., in cooperation with the receiver 905-a) and interpret a second stage of feedback for a downlink transmission. In some examples, the second stage of feedback may include a level of detail of feedback information that is greater than a level of detail of feedback information provided by a first stage of feedback. In some examples (e.g., when the first stage of feedback includes bundled feedback), the second stage of feedback may include separate feedback indications for at least two downlink transmissions (e.g., for a first downlink transmission and a second downlink transmission, a first portion and a second portion of a downlink transmission, etc.). In some examples, the second stage of feedback may include bundled feedback, but the bundled feedback of the first stage of feedback may be greater than the bundled feedback of the second stage of feedback (e.g., the second stage of feedback may contain less or more loosely bundled feedback). In other examples, the second stage of feedback may not include bundled feedback.

The components of wireless communications devices 900 or 1000 described with reference to FIG. 9 or 10 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., structured/platform ASICs, a FPGA, or another semi-custom IC), which may be programmed in any manner known in the art. The functions of each unit may also be implemented, in whole or in part, with instructions embodied in a memory, formatted to be executed by one or more general or application-specific processors.

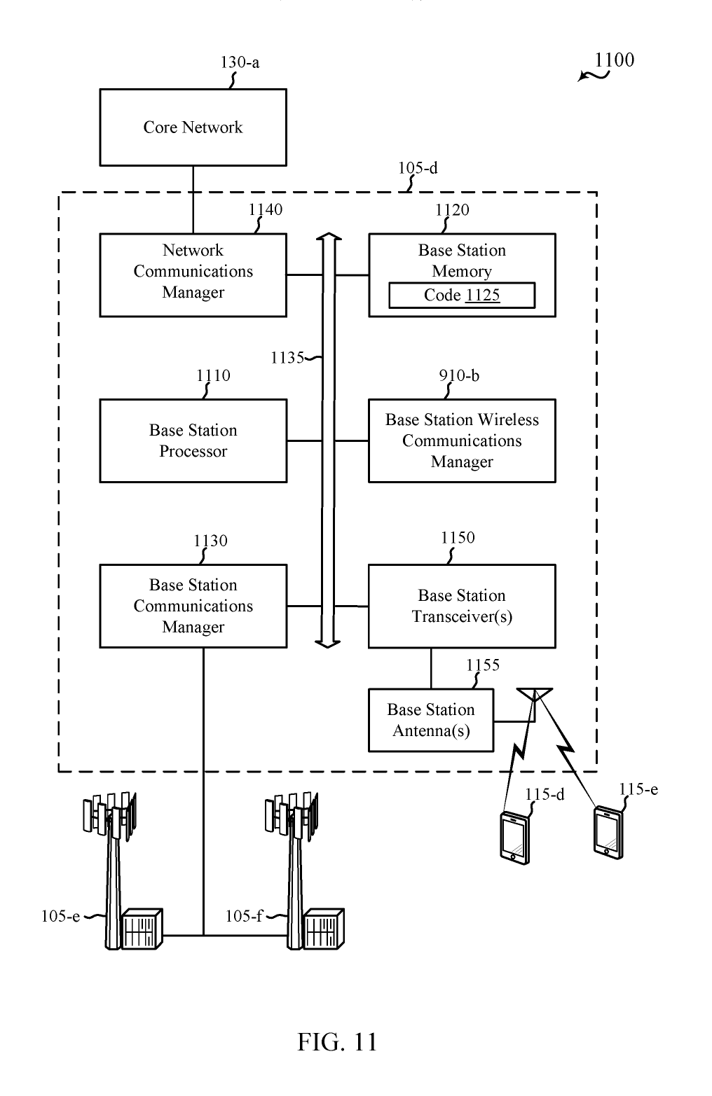

FIG. 11 shows a diagram 1100 of a base station 105-d (e.g., a base station forming part or all of an eNB) configured for two-stage reception of feedback for a downlink transmission, in accordance with aspects of the present disclosure. In some examples, the base station 105-d may be an example of aspects of one or more of the base stations 105 described with reference to FIGS. 1-4 or wireless communications devices 900 or 1000 described with reference to FIG. 9 or 10. The base station 105-d may be configured to implement or facilitate at least some of the base station or wireless communication device features and functions described with reference to FIG. 1-4, 9, or 10.

The base station 105-d may include a base station processor 1110, base station memory 1120, at least one base station transceiver (represented by base station transceiver(s) 1150), at least one base station antenna (represented by base station antenna(s) 1155), or a base station wireless communications manager 910-b. The base station 105-d may also include one or more of a base station communications manager 1130 or a network communications manager 1140. Each of these components may be in communication with each other, directly or indirectly, over one or more buses 1135.

The base station memory 1120 may include RAM or ROM. The base station memory 1120 may store computer-readable, computer-executable software/firmware code 1125 containing instructions that are configured to, when executed, cause the base station processor 1110 to perform various functions described herein related to wireless communication, including, for example, the reception of two-stage feedback for a downlink transmission, as described with reference to FIG. 1-4, 9, or 10. Alternatively, the code 1125 may not be directly executable by the base station processor 1110 but be configured to cause the base station 105-d (e.g., when compiled and executed) to perform various of the functions described herein.

The base station processor 1110 may include an intelligent hardware device, e.g., a CPU, a microcontroller, an ASIC, etc. The base station processor 1110 may process information received through the base station transceiver(s) 1150, the base station communications manager 1130, or the network communications manager 1140. The base station processor 1110 may also process information to be sent to the transceiver(s) 1150 for transmission through the antenna(s) 1155, to the base station communications manager 1130, for transmission to one or more other base stations 105-e and 105-f, or to the network communications manager 1140 for transmission to a core network 130-a, which may be an example of one or more aspects of the core network 130 described with reference to FIG. 1. The base station processor 1110 may handle, alone or in connection with the base station wireless communications manager 910-b, various aspects of communicating over (or managing communications over) a radio frequency spectrum band.

The base station transceiver(s) 1150 may include a modem configured to modulate packets and provide the modulated packets to the base station antenna(s) 1155 for transmission, and to demodulate packets received from the base station antenna(s) 1155. The base station transceiver(s) 1150 may, in some examples, be implemented as one or more base station transmitters and one or more separate base station receivers. The base station transceiver(s) 1150 may be configured to communicate bi-directionally, via the antenna(s) 1155, with one or more UEs or other devices, such as one or more of the UEs 115 (e.g., UE 115-d and UE 115-e) or devices described with reference to FIGS. 1-10. The base station 105-d may, for example, include multiple base station antennas 1155 (e.g., an antenna array). The base station 105-d may communicate with the core network 130-a through the network communications manager 1140. The base station 105-d may also communicate with other base stations, such as the base stations 105-e and 105-f, using the base station communications manager 1130.

The base station wireless communications manager 910-b may be configured to perform or control some or all of the features or functions described with reference to FIGS. 1-4 related to wireless communication over a radio frequency spectrum band. The base station wireless communications manager 910-b, or portions of it, may include a processor, or some or all of the functions of the base station wireless communications manager 910-b may be performed by the base station processor 1110 or in connection with the base station processor 1110. In some examples, the base station wireless communications manager 910-b may be an example of a base station wireless communications manager 910 described with reference to FIG. 9 or 10.

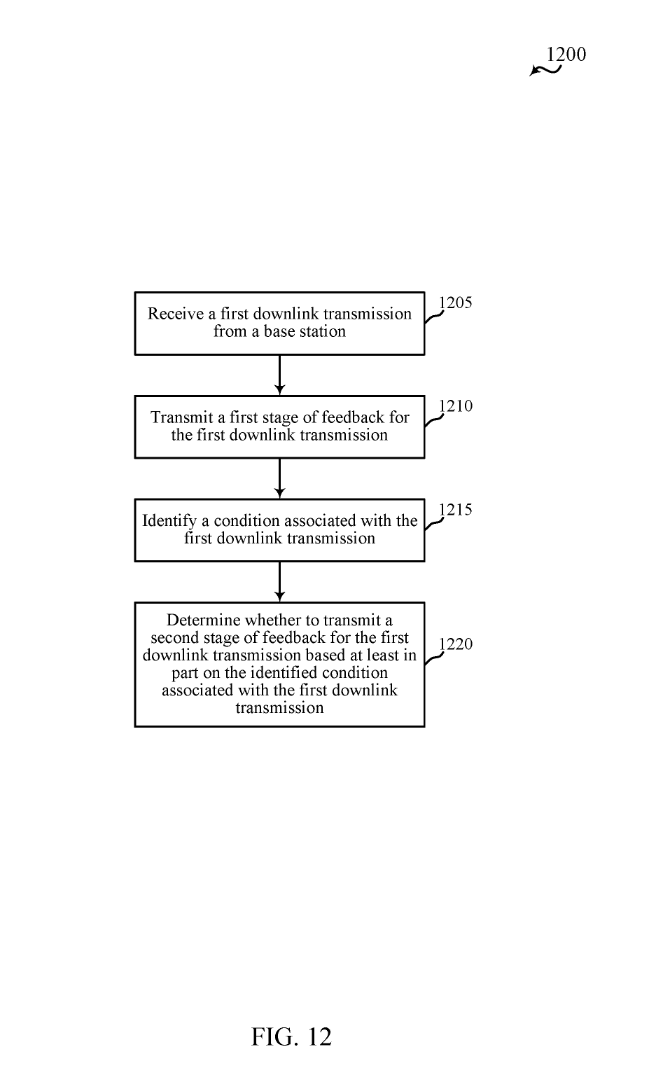

FIG. 12 shows a flowchart illustrating a method for two-stage transmission of feedback for a downlink transmission, in accordance with aspects of the present disclosure. The operations of method 1200 may be implemented by a device such as a UE 115 or its components, as described with reference to FIGS. 1-8. For example, the operations of method 1200 may be performed using a receiver 505, transmitter 515, transceiver(s) 830, and/or a UE wireless communications manager 510 described with reference to FIGS. 5-8. In some examples, a device may execute a set of codes to control the functional elements of the device to perform the functions described below. Additionally or alternatively, the device may perform aspects of the functions described below using special-purpose hardware.

At block 1205, the device may receive a first downlink transmission from a base station, as described with reference to FIGS. 3-4. In some examples, the operations of block 1205 may be performed by a receiver 505 and/or a UE wireless communications manager 510 described with reference to FIGS. 5 and 6.

At block 1210, the device may transmit a first stage of feedback for the first downlink transmission, as described with reference to FIGS. 3-4. In some examples, the operations of block 1210 may be performed by a first stage feedback manager 605 described with reference to FIGS. 6 and 7 and/or a transmitter 515 described with reference to FIGS. 5 and 6.

At block 1215, the device may identify a condition associated with the first downlink transmission, as described with reference to FIGS. 3-4. In some examples, the operations of block 1215 may be performed by a feedback condition identifier 610 described with reference to FIGS. 6 and 7.

At block 1220, the device may determine whether to transmit a second stage of feedback for the first downlink transmission based at least in part on the condition identified at block 1215, as described with reference to FIGS. 3-4. In some examples, the operations of block 1220 may be performed by a second stage feedback manager 615 described with reference to FIGS. 6 and 7.

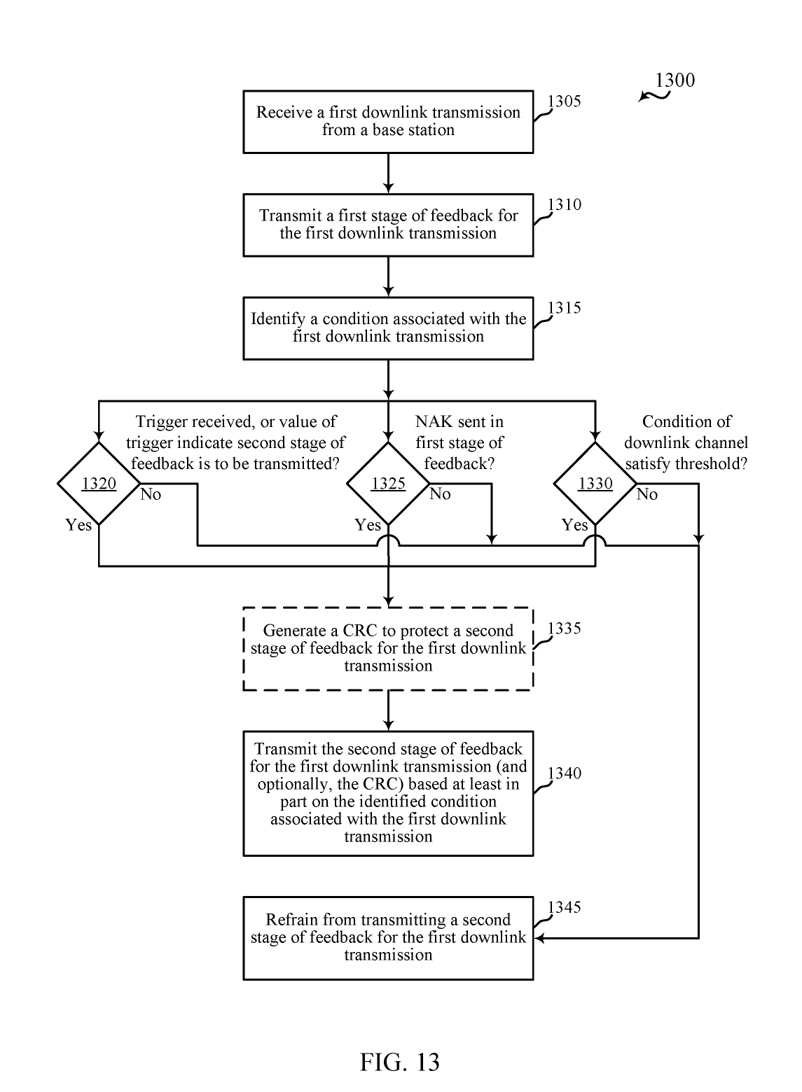

FIG. 13 shows a flowchart illustrating a method for two-stage transmission of feedback for a downlink transmission, in accordance with aspects of the present disclosure. The operations of method 1300 may be implemented by a device such as a UE 115 or its components, as described with reference to FIGS. 1-8. For example, the operations of method 1300 may be performed using a receiver 505, transmitter 515, transceiver (s) 830, and/or a UE wireless communications manager 510 described with reference to FIGS. 5-8. In some examples, a device may execute a set of codes to control the functional elements of the device to perform the functions described below. Additionally or alternatively, the device may perform aspects of the functions described below using special-purpose hardware.

At block 1305, the device may receive a first downlink transmission from a base station, as described with reference to FIGS. 3-4. In some examples, the operations of block 1305 may be performed by a receiver 505 and/or a UE wireless communications manager 510 described with reference to FIGS. 5 and 6.

At block 1310, the device may transmit a first stage of feedback for the first downlink transmission, as described with reference to FIGS. 3-4. In some examples, the first stage of feedback may be transmitted without a CRC. In some examples, the operations of block 1310 may be performed by a first stage feedback manager 605 described with reference to FIGS. 6 and 7 and/or a transmitter 515 described with reference to FIGS. 5 and 6.

At block 1315, the device may identify a condition associated with the first downlink transmission, as described with reference to FIGS. 3-4. The condition may include, for example, a trigger received from the base station, where the trigger may indicate whether the second stage of feedback is to be transmitted, a sending of a NAK in the first stage of feedback for the first downlink transmission, or a condition of a downlink channel used to receive the first downlink transmission. When the condition includes a trigger received from the base station, identifying the condition may include evaluating an information field of a downlink control channel received from the base station. In some examples, the operations of block 1315 may be performed by a feedback condition identifier 610 described with reference to FIGS. 6 and 7.

At one or more of blocks 1320, 1325, or 1330, the device may determine whether to transmit a second stage of feedback for the first downlink transmission based at least in part on the condition identified at block 1315, as described with reference to FIGS. 3-4. In some examples, the operations of block 1320, 1325, or 1330 may be performed by a second stage feedback manager 615 described with reference to FIGS. 6 and 7.

At block 1320, the device may determine whether a trigger has been received from the base station or whether a value of the trigger indicates the second stage of feedback is to be transmitted. When the trigger is received or indicates the second stage of feedback is to be transmitted, the method 1300 may continue to block 1335. When the trigger is not identified or does not indicate the second stage of feedback is to be transmitted, the method 1300 may proceed to block 1345. In some examples, the operations of block 1320 may be performed by a trigger analyzer 705 described with reference to FIG. 7.

At block 1325, the device may determine whether a NAK was sent in the first stage of feedback for the first downlink transmission. Upon determining that a NAK was sent, the method 1300 may continue to block 1335. Upon determining that a NAK was not sent, the method 1300 may proceed to block 1345. In some examples, the operations of block 1325 may be performed by a feedback analyzer 710 described with reference to FIG. 7.

At block 1330, the device may determine whether a condition of a downlink channel used to receive the first downlink transmission satisfies a threshold (e.g., the device may determine whether the condition of the downlink channel is poor). When the condition satisfies the threshold, the method 1300 may continue to block 1335. When the condition does not satisfy the threshold, the method 1300 may proceed to block 1345. In some examples, the operations of block 1330 may be performed by a channel condition analyzer 715 described with reference to FIG. 7.

At block 1335, the device may optionally generate a CRC to protect the second stage of feedback. In some examples, the operations of block 1335 may be performed by a CRC manager 720 described with reference to FIG. 7.

At block 1340, the device may transmit the second stage of feedback for the first downlink transmission (and optionally, the CRC generated at block 1335) based at least in part on the identified condition associated with the first downlink transmission, as described with reference to FIGS. 3-4. In some examples, CSI or a SR may be transmitted with the second stage of feedback. In some examples of the method 1300, the first stage of feedback may be transmitted in a first channel, and the second stage of feedback may be transmitted in a second channel. The first channel may include a shorter TTI duration than the second channel. In some examples of the method 1300, the second stage of feedback may be transmitted in a later TTI than the first stage of feedback. In some examples, the operations of block 1340 may be performed by a second stage feedback manager 615 described with reference to FIGS. 6 and 7, a CSI manager 725 or a SR manager 730 described with reference to FIG. 7, and/or a transmitter 515 described with reference to FIG. 5 or 6.

At block 1345, the device may refrain from transmitting the second stage of feedback for the first downlink transmission, as described with reference to FIGS. 3-4. In some examples, the operations of block 1345 may be performed by a second stage feedback manager 615-a described with reference to FIGS. 6 and 7.

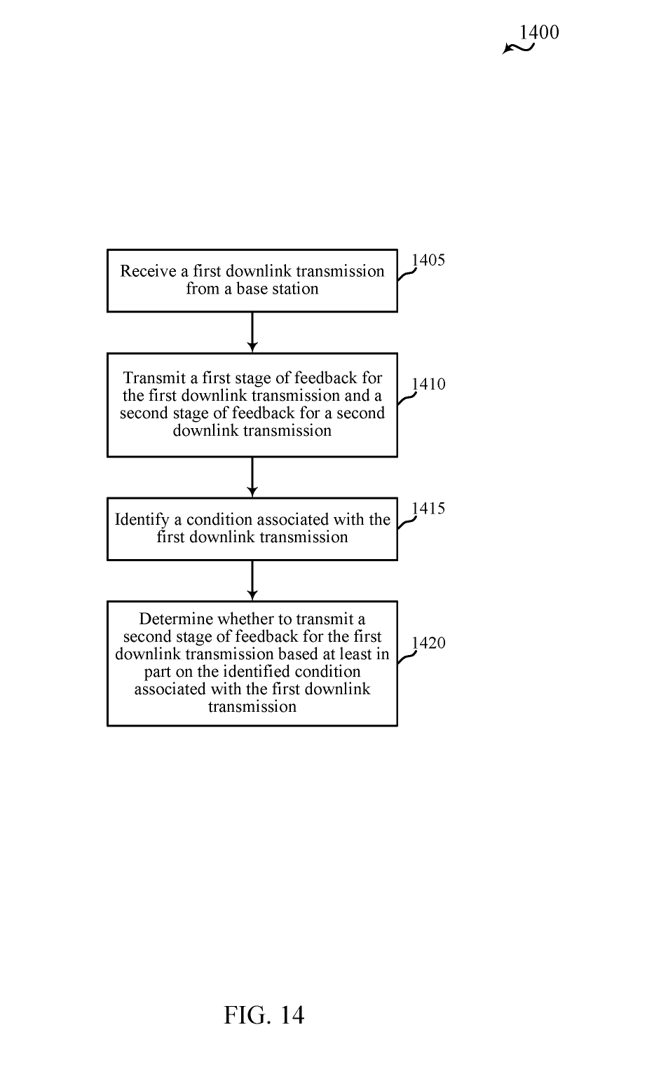

FIG. 14 shows a flowchart illustrating a method for two-stage transmission of feedback for a downlink transmission, in accordance with aspects of the present disclosure. The operations of method 1400 may be implemented by a device such as a UE 115 or its components, as described with reference to FIGS. 1-8. For example, the operations of method 1400 may be performed using a receiver 505, transmitter 515, transceiver(s) 830, and/or a UE wireless communications manager 510 described with reference to FIGS. 5-8. In some examples, a device may execute a set of codes to control the functional elements of the device to perform the functions described below. Additionally or alternatively, the device may perform aspects of the functions described below using special-purpose hardware.

At block 1405, the device may receive a first downlink transmission from a base station, as described with reference to FIGS. 3-4. In some examples, the operations of block 1405 may be performed by a receiver 505 and/or UE wireless communications manager 510 described with reference to FIGS. 5 and 6.

At block 1410, the device may transmit a first stage of feedback for the first downlink transmission and a second stage of feedback for a second downlink transmission. In some examples, the second stage of feedback for the second downlink transmission may be transmitted while transmitting the first stage of feedback for the first downlink transmission, and in some examples, the second stage of feedback for the second downlink transmission may be combined with the first stage of feedback for the first downlink transmission. In some examples, the operations of block 1410 may be performed by a first stage feedback manager 605 described with reference to FIGS. 6 and 7, a feedback process coordinator 735 described with reference to FIG. 7, and/or a transmitter 515 described with reference to FIGS. 5 and 6.

At block 1415, the device may identify a condition associated with the first downlink transmission, as described with reference to FIGS. 3-4. In some examples, the operations of block 1415 may be performed by a feedback condition identifier 610 described with reference to FIGS. 6 and 7.

At block 1420, the device may determine whether to transmit a second stage of feedback for the first downlink transmission based at least in part on the condition identified at block 1415, as described with reference to FIGS. 3-4. In some examples, the operations of block 1420 may be performed by a second stage feedback manager 615 described with reference to FIGS. 6 and 7.

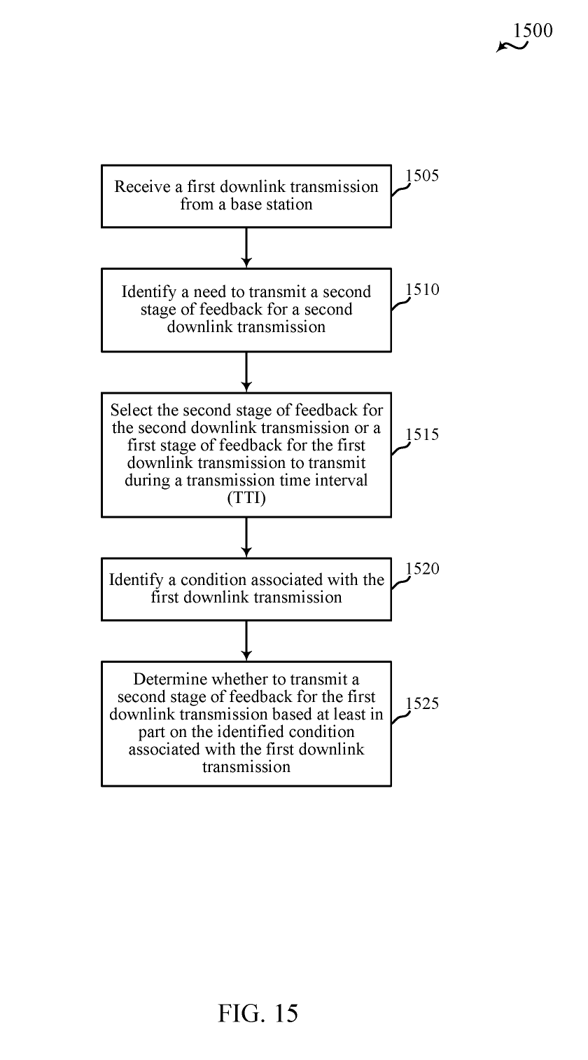

FIG. 15 shows a flowchart illustrating a method for two-stage transmission of feedback for a downlink transmission, in accordance with aspects of the present disclosure. The operations of method 1500 may be implemented by a device such as a UE 115 or its components, as described with reference to FIGS. 1-8. For example, the operations of method 1500 may be performed using a receiver 505, transmitter 515, transceiver(s) 830, and/or a UE wireless communications manager 510 described with reference to FIGS. 5-8. In some examples, a device may execute a set of codes to control the functional elements of the device to perform the functions described below. Additionally or alternatively, the device may perform aspects of the functions described below using special-purpose hardware.

At block 1505, the device may receive a first downlink transmission from a base station, as described with reference to FIGS. 3-4. In some examples, the operations of block 1505 may be performed by a receiver 505 and/or a UE wireless communications manager 510 described with reference to FIGS. 5 and 6.

At block 1510, the device may identify a need to transmit a second stage of feedback for a second downlink transmission. In some examples, the operations of block 1510 may be performed by a second stage feedback manager 615 described with reference to FIGS. 6 and 7, or by a feedback process coordinator 735 described with reference to FIG. 7.

At block 1515, the device may select the second stage of feedback for the second downlink transmission or a first stage of feedback for the first downlink transmission to transmit during a TTI. In some examples, the operations of block 1515 may be performed by a first stage feedback manager 605 or second stage feedback manager 615 described with reference to FIGS. 6 and 7, and/or a feedback process coordinator 735 described with reference to FIG. 7.

At block 1520, the device may identify a condition associated with the first downlink transmission, as described with reference to FIGS. 3-4. In some examples, the operations of block 1520 may be performed by a feedback condition identifier 610 described with reference to FIGS. 6 and 7.

At block 1525, the device may determine whether to transmit a second stage of feedback for the first downlink transmission based at least in part on the condition identified at block 1515, as described with reference to FIGS. 3-4. In some examples, the operations of block 1525 may be performed by a second stage feedback manager 615 described with reference to FIGS. 6 and 7.

Thus, methods 1200, 1300, 1400, and 1500 may provide for two-stage transmission of feedback for a downlink transmission. It should be noted that methods 1200, 1300, 1400, and 1500 describe possible implementation, and that the operations and the steps may be rearranged or otherwise modified such that other implementations are possible. In some examples, aspects from two or more of the methods 1200, 1300, 1400, and 1500 may be combined.

The detailed description set forth above in connection with the appended drawings describes examples and does not represent all of the examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM, CD-ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for wireless communication at a user equipment (UE), comprising:
receiving a first downlink transmission from a base station;
transmitting a first stage of feedback for the first downlink transmission;
identifying a condition associated with the first downlink transmission; and
determining whether to transmit a second stage of feedback for the first downlink transmission based at least in part on the identified condition associated with the first downlink transmission.

2. The method of claim 1, further comprising:
transmitting the second stage of feedback for the first downlink transmission based at least in part on the identified condition associated with the first downlink transmission.

3. The method of claim 1, wherein the identified condition comprises a trigger received from the base station, the trigger indicating whether the second stage of feedback is to be transmitted.

4. The method of claim 3, further comprising:
evaluating an information field of a downlink control channel received from the base station to identify the trigger.

5. The method of claim 3, wherein the trigger comprises a per-UE trigger, a per-cell trigger, or both.

6. The method of claim 1, wherein the identified condition comprises a condition of a downlink channel used to receive the first downlink transmission.

7. The method of claim 1, wherein the second stage of feedback comprises a first level of detail of feedback information that is greater than a second level of detail of feedback information provided by the first stage of feedback.

8. The method of claim 1, further comprising:
transmitting the first stage of feedback in a first channel; and
transmitting the second stage of feedback in a second channel, the first channel comprising a shorter transmission time interval (TTI) duration than the second channel.

9. The method of claim 1, wherein the first stage of feedback comprises bundled feedback in a time-domain, in a component carrier (CC)-domain, in a spatial-domain, or in a combination thereof.

10. The method of claim 9, wherein the second stage of feedback comprises separate feedback indications for at least a first portion of the first downlink transmission and a second portion of the first downlink transmission.

11. The method of claim 1, wherein the first downlink transmission comprises a downlink transmission comprising a transmission time interval (TTI) duration less than a subframe duration, a downlink transmission received over a dedicated radio frequency spectrum band, a downlink transmission received in a shared radio frequency spectrum band, at least two downlink transmissions included in a carrier aggregation operation, or a combination thereof.

12. The method of claim 1, further comprising:
transmitting the second stage of feedback in a later transmission time interval (TTI) than the first stage of feedback.

13. The method of claim 1, further comprising:
transmitting the first stage of feedback without a cyclic redundancy check (CRC); and
generating and transmitting a CRC to protect the second stage of feedback.

14. The method of claim 1, further comprising:
transmitting at least one of channel state information (CSI) or a scheduling request (SR) with the second stage of feedback.

15. The method of claim 1, further comprising:
transmitting the second stage of feedback for a second downlink transmission while transmitting the first stage of feedback for the first downlink transmission.

16. The method of claim 1, further comprising:
identifying a need to transmit the second stage of feedback for a second downlink transmission; and
selecting the second stage of feedback for the second downlink transmission or the first stage of feedback for the first downlink transmission to transmit during a transmission time interval (TTI).

17. The method of claim 1, wherein the first stage of feedback and the second stage of feedback are transmitted on a same carrier or are transmitted on different carriers.

18. An apparatus for wireless communication at a user equipment (UE), comprising:
a processor;
memory in electronic communication with the processor; and
instructions stored in the memory, the instructions being executable by the processor to:
receive a first downlink transmission from a base station;
transmit a first stage of feedback for the first downlink transmission;
identify a condition associated with the first downlink transmission; and
determine whether to transmit a second stage of feedback for the first downlink transmission based at least in part on the identified condition associated with the first downlink transmission.

19. The apparatus of claim 18, wherein the instructions are executable by the processor to:
transmit the second stage of feedback for the first downlink transmission based at least in part on the identified condition associated with the first downlink transmission.

20. A non-transitory computer-readable medium storing computer-executable code for wireless communication, the code executable by a processor to:
receive a first downlink transmission from a base station;
transmit a first stage of feedback for the first downlink transmission;
identify a condition associated with the first downlink transmission; and
determine whether to transmit a second stage of feedback for the first downlink transmission based at least in part on the identified condition associated with the first downlink transmission.
